(19) United States
(12) Patent Application Publication
(10) Pub. No.: US 2025/0173601 A1
(43) Pub. Date: May 29, 2025

(54) TECHNIQUES FOR VISUALIZING FEATURE ENGINEERING PIPELINES

(71) Applicant: Oracle International Corporation, Redwood Shores, CA (US)

(72) Inventors: Kapil Sharma, Faridabad (IN); Ishaan Arora, Moga (IN); Priyam Gupta, Lucknow (IN)

(73) Assignee: Oracle International Corporation, Redwood Shores, CA (US)

(21) Appl. No.: 18/520,260

(22) Filed: Nov. 27, 2023

(51) Int. Cl. G06N 20/00; G06F 3/0484

(52) U.S. Cl. CPC G06N 20/00; G06F 3/0484

(57) ABSTRACT

Techniques may include presenting a graphical user interface for creating a pipeline to transform data from a first to a second format. The interface may include an interactive workspace and a logical entity library, and the pipeline may include two or more logical entities. Each logical entity in the logical entity library may include at least one of a data processing node, a debugging node, or an administrative node. In addition, the techniques may include receiving information identifying a logical entity for each entity in the pipeline. The techniques may include receiving information identifying a location within the interactive workspace for the logical entity and information identifying a configuration corresponding to the logical entity. The techniques may include visually representing graphical connection between each logical entity in the pipeline and at least one additional logical entity in the pipeline. Moreover, the techniques may include transforming data to produce transformed data.

### BACKGROUND

Machine learning models can be trained to perform various tasks without explicit instructions for how each task should be accomplished. Instead, a model is trained by inputting data, and iteratively tuning model parameters, until the model produces the desired output for a given input. This training paradigm can allow a model to detect patterns in data that would not be obvious to a human analyzing the same dataset. The input for these models may be generated via feature engineering pipelines which can be difficult or time consuming to create or modify. Accordingly, improvements to feature engineering pipelines are desirable.

### BRIEF SUMMARY

A system of one or more computers can be configured to perform the disclosed techniques by virtue of having software, firmware, hardware, or a combination of them installed on the system that in operation causes or cause the system to perform actions or operations corresponding to the techniques. This hardware can include one or more non-transitory computer readable media and one or more processors. One or more computer programs can be configured to perform the disclosed techniques by virtue of including instructions that, when executed by data processors, cause the apparatus to perform the actions or operations corresponding to the techniques.

In one general aspect, techniques may include presenting a graphical user interface for creating a pipeline to transform data from a first format to a second format. The graphical user interface may include an interactive workspace and a logical entity library, and the pipeline may include two or more logical entities. Each logical entity in the logical entity library may include at least one of a data processing node, a debugging node, or an administrative node. The techniques may also include for each logical entity in the pipeline: receiving information identifying a logical entity from the logical entity library; receiving information identifying a location within the interactive workspace for the logical entity; and receiving information identifying a configuration corresponding to the logical entity. The techniques may furthermore include visually representing a graphical connection between each logical entity in the pipeline and at least one additional logical entity in the pipeline, where the graphical connection indicates a flow of data in the pipeline. The techniques may in addition include transforming data from the first format to the second format to produce transformed data based at least in part on the two or more logical entities having the pipeline. Other embodiments of these techniques include corresponding computer systems, apparatus, and computer programs recorded on one or more non-transitory computer storage devices or non-transitory computer readable mediums, each configured to perform the actions of the techniques.

Implementations may include one or more of the following techniques. Techniques where visually representing the graphical connection between each logical entity further may include: visually representing, via the graphical user interface of the computing device, two or more graphical connections between a logical entity in the pipeline and at least two additional logical entities. Techniques where the at least two additional logical entities may include a data processing node and a debugging node. Techniques where presenting the graphical user interface may include: accessing, by the computing device, the logical entity library; and registering, by the computing device, the logical entity library with the graphical user interface. Method where the first format may include unprocessed data and the second format may include input to a machine learning model. Techniques may include: training, by the computing device, a machine learning model on the transformed data in the second format. Techniques may include: storing, by the computing device, the transformed data in a memory of the computing device. Other embodiments of these techniques include corresponding computer systems, apparatus, and computer programs recorded on one or more non-transitory computer storage devices or non-transitory computer readable mediums, each configured to perform the actions of the techniques.

### BRIEF DESCRIPTION OF THE DRAWINGS

FIG. 1 shows a simplified diagram of a technique for feature generation according to at least one embodiment.

FIG. 2 shows a simplified diagram of a technique for feature consumption according to at least one embodiment.

FIG. 3 is a simplified diagram of a graphical user interface with an interactive workspace for creating a feature engineering pipeline according to at least one embodiment.

FIG. 4 shows a simplified diagram of a method for creating a pipeline for transforming data according to at least one embodiment.

FIG. 5 shows a block diagram of a computer system according to at least one embodiment.

FIG. 6 is a block diagram illustrating one pattern for implementing a cloud infrastructure as a service system, according to at least one embodiment.

FIG. 7 is a block diagram illustrating another pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating an example computer system, according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Obtaining sufficient intelligible training data is a common problem with training machine learning models. A model may need thousands to millions of datapoints in order to detect patterns that allow the model to perform a particular task. In addition, in some instances, the data must be in a format that is intelligible to the model. Humans naturally transform data into different formats and a human may be able to deduce that each of the following formats refer to the same date: Oct. 1, 2023, 01.10.23, Oct. 1, 2023 and 2023 Oct. 1. However, a model's application programming interface (API) may specify a particular format for ingesting data (e.g., eight number dates with the first four numbers indicating the year, numbers five and six indicating the month, and numbers seven and eight indicating the day). Accordingly, a numerical date submitted in a month, day, year order would be misinterpreted by the model.

Data can be gathered, and transformed into an appropriate format, e.g., through feature engineering. Feature engineering is the process of transforming raw data (e.g., data as obtained from a source) into a format that is intelligible to the model, and data in this intelligible format are known as features. Feature engineering generally involves a feature engineering pipeline, and, for example, the pipeline may involve extracting data from a data source, transforming the extracted data into a desired format, grouping the data into training datasets, and associating the dataset with a model. The interdependency of these steps, and the API requirements for each step, can make designing a feature engineering pipeline challenging and time consuming.

Embodiments of the present disclosure provide techniques for implementing a feature engineering pipeline. The techniques include a graphical user interface where the feature engineering pipeline is represented as a series of graphical objects. Instead of coding each step in the pipeline, the steps can be represented as graphical objects representing logical entities. To create a pipeline, a user selects graphical objects representing each desired step from a logical entity library and places the selected objects in an interactive workspace. The user can specify the flow of data within this pipeline by graphically connecting the objects (e.g., drawing a line between objects).

These techniques can provide a technical benefit by simplifying the creation of a data engineering pipeline by automating the flow of data between objects. Using these techniques, the user does not need to understand the application programming interface (API) specification for each logical entity. Instead, the API format for each logical entity is included in the logical entity library. When a user connects two entities, the graphical user interface system determines the output format for the first logical entity and the input format for the second entity. Using this information, the system transforms the output from the first logical entity to a format that is intelligible to the second logical entity without additional user input. In addition, the pipeline can be built in any order without needing to sequentially create a pipeline from start to finish.

The disclosed techniques can provide a technical benefit by facilitate debugging a feature engineering pipeline. Each graphical object in the feature engineering pipeline can include a status indicator (e.g., completed, running, error, etc.). These status indicators can help a user visually identify error locations and rate limiting steps in the pipeline. In written code, without a visual representation, it can be difficult to determine which logical entity in the pipeline is causing an error.

In addition, the logical entity library can include logical entities that can be used to debug a pipeline. These debugging entities can display the output of any connected logical entity. Without a debugging entity, a user would have to modify the feature engineering pipeline's code to view a step's output. These modifications can be time consuming and can require a detailed understanding of the pipeline's underlying code and API specifications. These problems are compounded if the debugging user did not write the pipeline's code, and, in such circumstances, the user may have to analyze and understand unrelated parts of the pipeline's before debugging a specific problem. Accordingly, these logical entities can simplify and speed debugging a feature engineering pipeline.

In an illustrative example, a user wants to train a machine learning model to predict whether a dog is a bite risk. The user locates a website that publishes data for dog bite incidents in the American Midwest. The dataset includes victim demographics (e.g., age, race, sex, etc.), dog demographics (e.g., age, breed, sex, weight, color, etc.), and information about the attack (e.g., address, time of day, etc.). The data contains irrelevant information that may bias the model (e.g., dog color; location and time of the attack) user needs to turn this data into a dataset that can be input to a machine learning model during training. The user could manually filter the data, however, the website publishes this data regularly and the user can save a significant amount of time by using an automated feature engineering pipeline to transform the data.

To create the feature engineering pipeline, the user opens a graphical user interface with an interactive workspace. The user selects graphics representing logical entities for each step in the pipeline from a library in the interface and places the graphics in the workspace. The user links these graphics and, after configuring, the user runs the pipeline. The pipeline fails to properly execute and the node representing a “transformation” step indicates that the step has failed. To debug this step, the user drags a debugging node from the library and reruns the pipeline and the output from the “transformation” step is presented to the user by the debugging graphic. After reviewing the output, the user reconfigures the transformation step and successfully runs the pipeline to produce the training dataset.

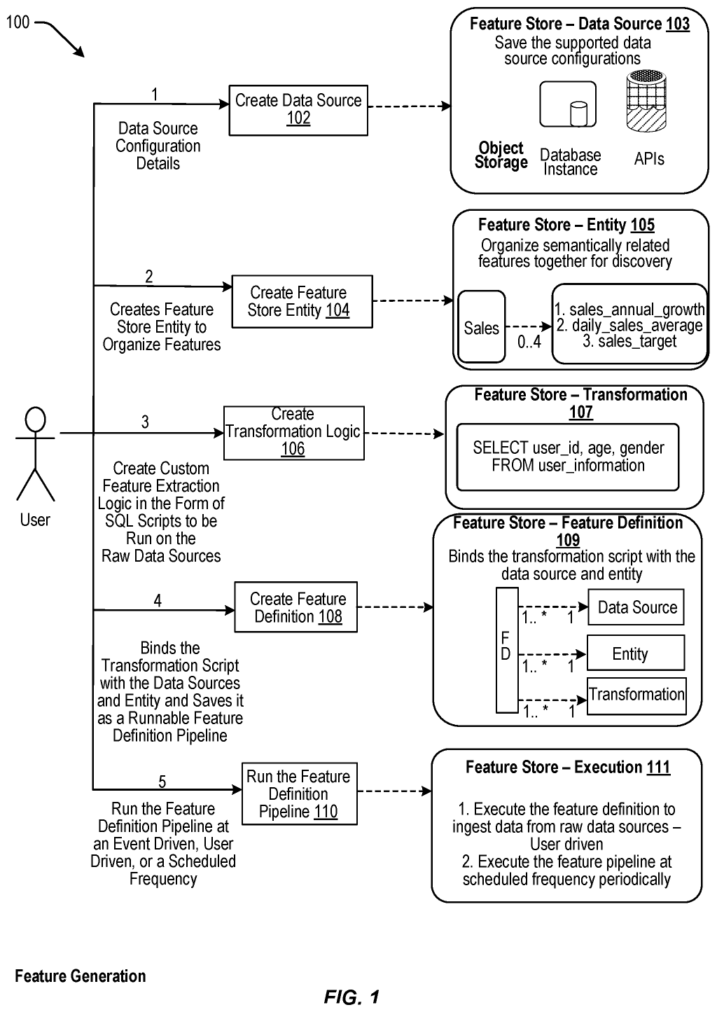

FIG. 1 shows a simplified diagram 100 of a technique for feature generation according to at least one embodiment. Feature generation, as shown in diagram 100, can be accomplished as part of a feature engineering pipeline. This technique is illustrated as a logical flow diagram, each operation of which can be implemented in hardware, computer instructions, or a combination thereof. In the context of computer instructions, the operations may represent computer-executable instructions stored on one or more computer-readable storage media that, when executed by one or more processors, perform the recited operations. Generally, computer-executable instructions include routines, programs, objects, components, data structures and the like that perform particular functions or implement particular data types. The orders in which the operations are described are not intended to be construed as a limitation, and any number of the described operations can be combined in any order and/or in parallel to implement the techniques.

Turning now to diagram 100 in greater detail, at step 102 a data source 103 can be created. Creating a data source can include identifying the data source and creating data source configuration details. For instance, data source configuration details can include specifying a data source such as object storage, data warehouses, databases, message busses, application programming interfaces (APIs), etc. The data source configuration details may include formatting information for a data source such as a filetype or header information. Configuring the data source can also specifying a location where the data will be stored.

At step 104, a feature store entity 105 can be created. A feature store is a central repository for the pipeline's features, and a feature store helps ensure that consistent features are used across different stages of model training (e.g., the same feature types are used in training and evaluation). An entity in a feature store (e.g., a feature store entity 105) can be a logical entity that is used to organize related features. A logical entity can be a label that is used to group data and/or represent relationships between data. For example, a feature store entity can be created for a geographic region (e.g., Texas) and the feature store entity can include all data related to the geographic region (e.g., Texas weather data and sales data).

At step 106, transformation logic for a transformation 107 can be created. This transformation logic can define how data is filtered (e.g., which data to exclude or include from a dataset) or formatted (e.g., the manner in which the data is represented). For example, data organized under a “weather” feature object may include global weather data including atmospheric pressure, temperature, and humidity. This data was generated locally and includes both metric and imperial units. Transformation logic can specify that the data is filtered to exclude humidity and atmospheric pressure. The transformation logic can also specify that the temperature is converted into metric units.

At step 108, a feature definition 109 can be created for the transformed data. The feature definition can be an association between a feature store entity from step 104, the entity's corresponding source from step 102, and the entity's corresponding transformation logic from step 106. The feature definition can be specified in code that can be executed as a feature definition pipeline.

At step 110, the feature definition can be run to perform an execution 111. Upon the execution 111, the data can be extracted from the data sources specified at step 102, the extracted data can be organized into entities specified at step 104, and transformed using the transformation logic from step 106. The feature definition can be executed at scheduled intervals, in response to a user request, or in response to an event.

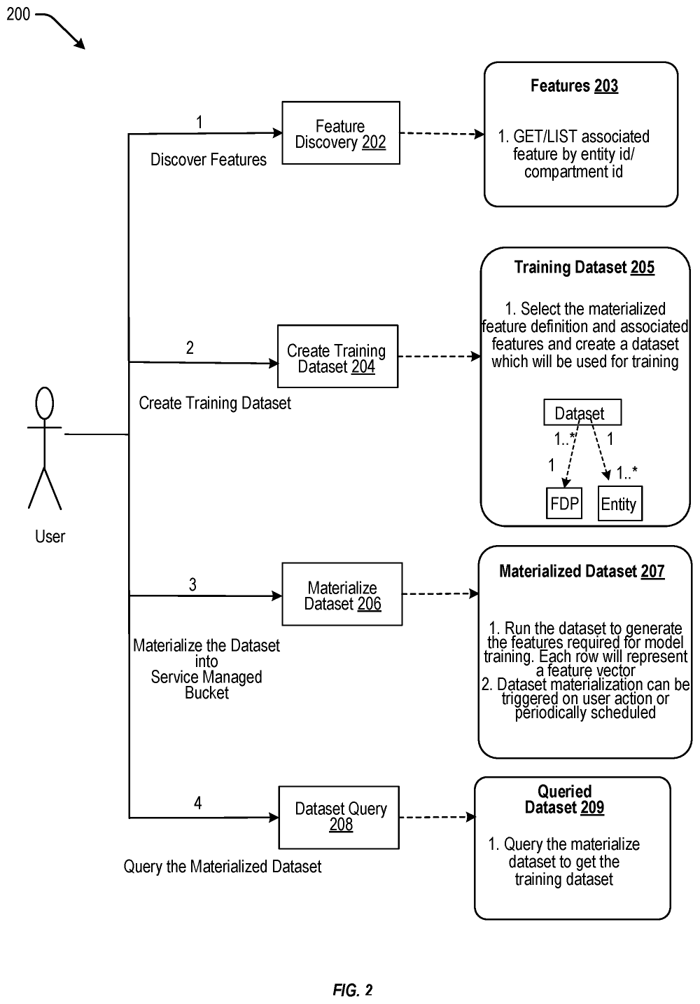

FIG. 2 shows a simplified diagram 200 of a technique for feature consumption according to at least one embodiment. Feature consumption, as shown in diagram 200, can be accomplished as part of a feature engineering pipeline. This technique is illustrated as a logical flow diagram, each operation of which can be implemented in hardware, computer instructions, or a combination thereof. In the context of computer instructions, the operations may represent computer-executable instructions stored on one or more computer-readable storage media that, when executed by one or more processors, perform the recited operations. Generally, computer-executable instructions include routines, programs, objects, components, data structures and the like that perform particular functions or implement particular data types. The orders in which the operations are described are not intended to be construed as a limitation, and any number of the described operations can be combined in any order and/or in parallel to implement the techniques.

At step 202, the features 203 generated according to the technique shown in diagram 100 can be discovered. Feature discovery can involve retrieving data according to different criteria. For example, the data associated with a specific feature store entity can be retrieved as part of feature discovery. This data can be retrieved using a unique identifier associated with a particular entity (e.g., an entity ID). Feature discovery can include generating and presenting statistics or other information gathered from the retrieved data. For example, feature discovery may include identifying missing data from the retrieved data.

At step 204, a training dataset 205 may be created. Training a machine learning model may include training data and evaluation data. The model is trained on the training data and model parameters are iteratively adjusted until the model satisfies a specified criterion. For example, a model may be trained to classify data. The model can be trained until the model's output satisfies an accuracy metric. However, the model may become overfit to the data (e.g., the model's predictions are not generalizable to data outside of the training dataset). Accordingly, the model's performance may be evaluated on an evaluation dataset that was not used during training. Creating a training dataset can include identifying features that are included in the dataset by selecting feature definitions or feature store entities that correspond to included features. The data corresponding to these identified features may be segregated into one or more training datasets and one or more evaluation datasets.

At step 206, the datasets 205 created at step 204 can be materialized and stored in compartments to produce a materialized dataset 207. For example, the compartment can be a bucket such as a service managed bucket. The features can be stored in the compartment as feature vectors that can be provided to a model as an input. A feature vector can be an ordered numerical representation of the features from the dataset created at step 204. For example, a feature vector for weather can include numerical code identifying a location corresponding to the weather, a date for the information in the vector, a number representing the precipitation in millimeters, a high temperature in Celsius and a low temperature in Celsius. These feature vectors can be stored in the compartment as a table with each row in the table representing a feature vector. The dataset can be materialized at regular intervals, in response to an event, or in response to a user request.

At step 208, one or more of the materialized datasets 207 from step 206 can be queried to retrieve a particular queried dataset 209. In some embodiments, multiple datasets can be queried simultaneously. A query can be used to retrieve a dataset that is used to train or evaluate a machine learning model.

The techniques shown in diagrams 100-200 can be performed using a graphical user interface with an interactive workspace for creating a feature engineering pipeline. The user interface can ensure that data is in an appropriate format as it moves from each step in the technique. Each step may include different application programming interfaces (API), and the data will not be intelligible to the next step if the formatting for the API is not followed. Without a graphical user interface, problems caused by data formatting can be difficult to debug because a user may not understand which step caused the error. In addition, updating a pipeline without a graphical user interface may be difficult unless the user modifying the pipeline understands the API at each step in the pipeline.

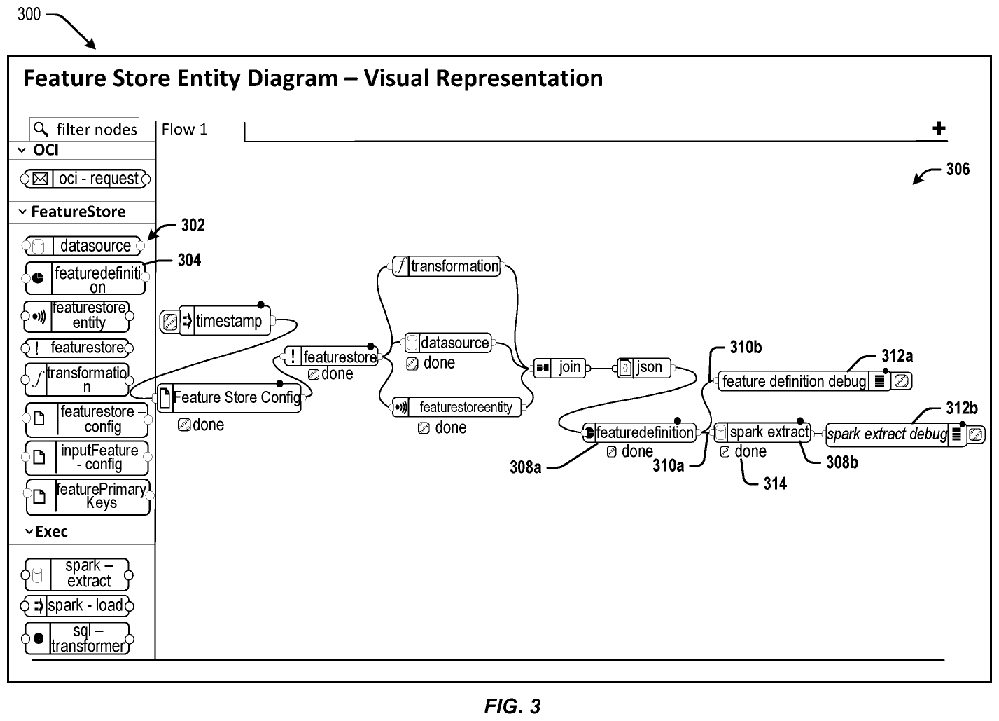

FIG. 3 is a simplified diagram 300 of a graphical user interface with an interactive workspace for creating a feature engineering pipeline according to at least one embodiment. The user interface shown in diagram 300 can be used to implement the techniques shown in diagrams 100-200. To initialize the graphical user interface, a software development kit package may be downloaded from a package management repository. Once download, the software development kit repository can be registered with a user interface platform that allows for low code software development (e.g., Node-RED).

Turning now to diagram 300 in greater detail, library 302 (e.g., logical entity library) contains template nodes 304 that are templates for logical entities (e.g., nodes) corresponding to steps in a feature engineering pipeline. To create a feature engineering pipeline, a user can select a template node (e.g., template node 304) from library 302 and specify a location for the node in the interactive workspace 306 (e.g., input coordinates; drag-and-drop). Template graphics can include templates for any of the steps shown in the techniques depicted in diagrams 100-200 including: data sources, server, feature definition, a transformation, a dataset, a machine learning model, a feature store, etc. These steps can be represented as data processing nodes in a logical entity library. In addition, the graphical user interface can be used to import an existing pipeline, modifying an imported pipeline, or exporting a pipeline. These functions can be represented as administrative nodes in a logical entity library.

The user can configure the placed templates graphics to specify how data is handled at each step in the pipeline. However, the user interface is “low-code” and the flow of data between nodes is preconfigured by the user interface platform. Accordingly, the user does not need to specify the specific format for data traveling between steps. Once configured, the template node (e.g., template node 304) can be a pipeline step (e.g., step 308a). For example, a filtering step can be configured to specify which data is retained after filtering. In some embodiments, a user can write code to configure a step. In such embodiments, the graphical user interface can present an integrated development environment in response to user input, and the user can provide code configuring a particular template node via this environment. In some embodiments, the other techniques can be used to configure the step such as selecting preset configurations via a menu or administrative nodes.

The user can define the flow of information in the feature engineering pipeline by linking steps via connectors (e.g., connectors 310a-310b). The connector can specify the direction for the flow of information, and, for example, an arrow can identify a destination for the information. In addition or alternatively, the point at which the connector is attached to a step can specify the flow of information. As shown in diagram 300, connector 310a is attached to the right side of one step 308a (e.g., the information source) and the left side of another step 308b (e.g., the information destination). Each step can be attached to multiple connectors but each connector may only have one information source and one information destination. Once two steps are connected, the user interface can determine the output format corresponding to the information source and the input format corresponding to the information destination. The user interface can automatically transform the data from the output format to the input format without additional user input.

The pipeline depicted in diagram 300 can include debugging steps (e.g., debugging steps 312a-312b). The debugging steps can be represented in logical entity library (e.g., library 302) as debugging nodes, and the debugging nodes can be attached to a step in the pipeline by a connector. For example, step 308a is connected to debugging step 312a by a connector 310b. Upon execution, a debugging step can present the output of a connected step, export the output to another program, or save the output to a file. Debugging steps can be attached to multiple steps in a pipeline to help a user debug the pipeline without having to modify the pipeline's code. In addition, a status indicator 314 can indicate whether a corresponding step (e.g., step 308b) has successfully executed (e.g., “done”), has failed, or if the step is still executing.

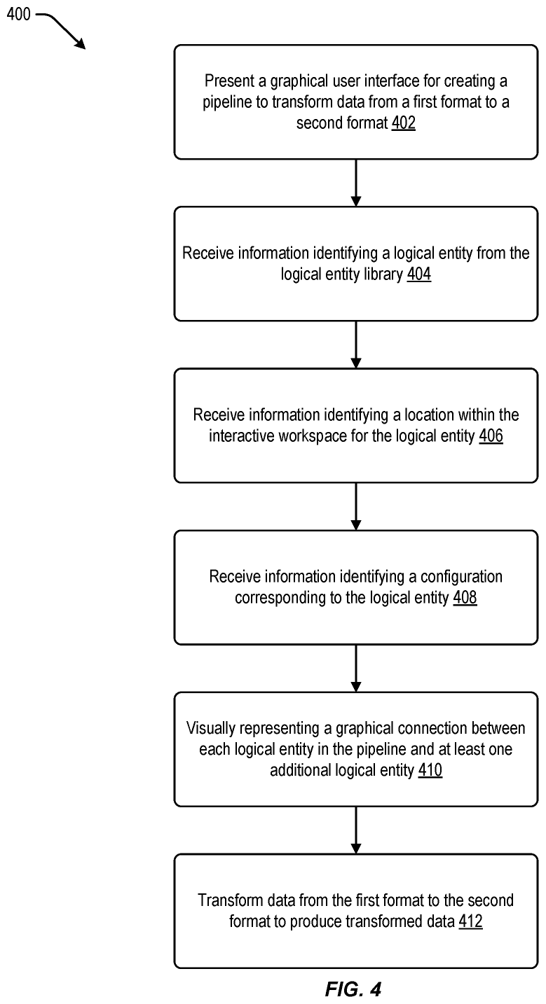

FIG. 4 shows a simplified diagram of a method 400 for creating a pipeline for transforming data according to at least one embodiment. This method is illustrated as a logical flow diagram, each operation of which can be implemented in hardware, computer instructions, or a combination thereof. In the context of computer instructions, the operations may represent computer-executable instructions stored on one or more computer-readable storage media that, when executed by one or more processors, perform the recited operations. Generally, computer-executable instructions include routines, programs, objects, components, data structures and the like that perform particular functions or implement particular data types. The orders in which the operations are described are not intended to be construed as a limitation, and any number of the described operations can be combined in any order and/or in parallel to implement the processes or the method. Method 400, and any of the other techniques of this disclosure can be implemented using the computer system 500 described below.

Turning now to method 400 in greater detail, at step 402, a graphical user interface for creating a pipeline to transform data from a first format to a second format can be presented. The graphical user interface can include an interactive workspace and a logical entity library. The logical entity library can include logical entities such as data processing nodes, debugging nodes, and administrative nodes. The first format can be raw data (e.g., unprocessed data; data obtained from a third party; data obtained from a publishing source). The second format can be a format that can be input to a machine learning model. For example, the second format can be a feature vector. The user interface can be the user interface shown in diagram 300, the interactive workspace can be interactive workspace 306, and the logical entity library can be library 302.

Presenting the graphical user interface can include downloading a software development kit package from a package management repository. Once download, the software development kit repository can be registered with a user interface platform that allows for low code software development (e.g., Node-RED). For example, a logical entity library can be accessed by a computing device and registered with a graphical user interface.

At step 404, information identifying a logical entity in the logical entity library can be received. The information can be received via the graphical user interface from step 402. Steps 404-408 can be performed for each logical entity in the pipeline. The information can be a user input to the graphical user interface. For example, a user can select node 304 by clicking on the node with a mouse or a touchscreen.

At step 406, information identifying a location corresponding to a logical entity can be received. The location can be a location within the interactive workspace. The information can be received via the graphical user interface from step 402. The information can be provided as coordinates (e.g., x-y cartesian coordinates) that are provided numerically or by providing an input to the graphical user interface. For example, a user can click a location on the interactive workspace 306 and the corresponding coordinates can be recorded as the location. In some embodiments, a node 304 can be “dragged and dropped” from the library 302 to the interactive workspace 306 (e.g., by providing a first input to select the node and a second input to place the node) and the coordinates of the dropped location can be stored as the location.

At step 408, information identifying a configuration corresponding to the logical entity can be received. The information can be received via the graphical user interface from step 402. The configuration corresponding to the logical entity can be provided by providing information identifying a configuration file. In some embodiments, a user can provide input to the user interface that opens a software development environment (e.g., a command prompt, a text file, an integrated development environment, etc.) and the configuration can be provided as code.

At step 410, a graphical connection between each logical entity in the pipeline and at least one additional logical entity can be visually represented. For example, the connection can be visually represented by a connector such as connectors 310a-310b. The graphical connection can represent a flow of data in the pipeline (e.g., a data source, a data destination, and a direction of travel for the data).

Visually representing a graphical connection between each logical entity can include visually representing two or more graphical connections between a logical entity in the pipeline and at least two additional logical entities. These additional logical entities can include one or more of a data processing node or a debugging node. In addition, one or more of the nodes may include a status indicator that indicates whether the step corresponding to the node has been completed, is in progress, or has failed.

At step 412, the data can be transformed from the first format to the second format to produce transformed data. The transformation may be based at least in part on the two or more logical entities comprising the pipeline. In addition or alternatively, the transformation may be based at least in part on the graphical connections between logical entities. The transformed data may be stored in a memory of a computing device. In some cases, the transformed data may be presented to a user via a display device.

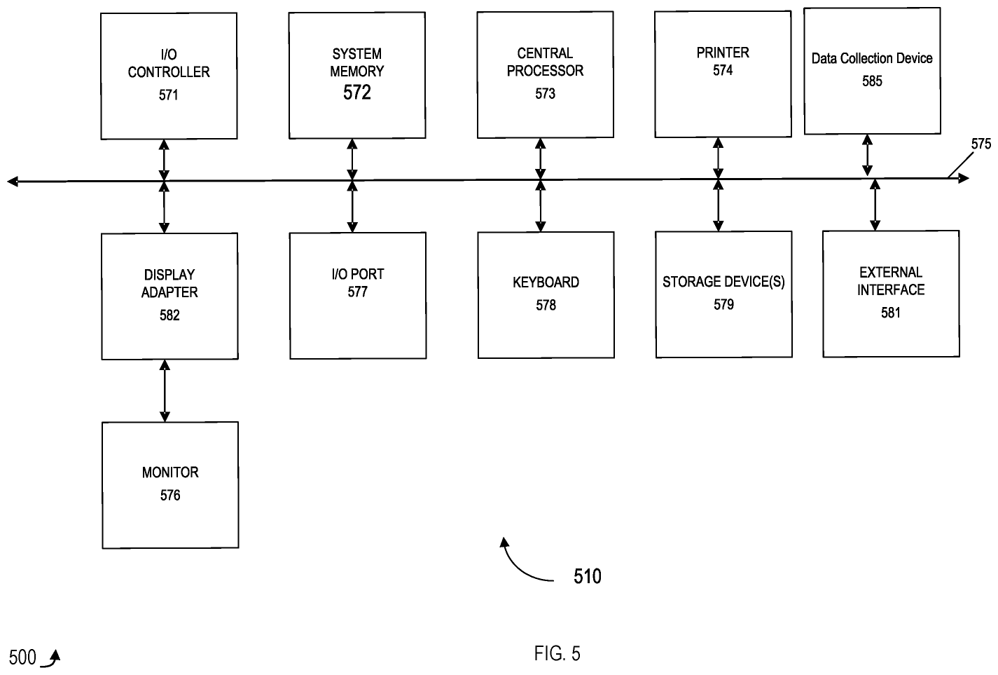

Any of the computer systems mentioned herein may utilize any suitable number of subsystems. Examples of such subsystems are shown in FIG. 5 in computer system 510. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 5 are interconnected via a system bus 575. Additional subsystems such as a printer 574, keyboard 578, storage device(s) 579, monitor 576 (e.g., a display screen, such as an LED), which is coupled to display adapter 582, and others are shown. Peripherals and input/output (I/O) devices, which couple to I/O controller 571, can be connected to the computer system by any number of means known in the art such as input/output (I/O) port 577 (e.g., USB, FireWire®). For example, I/O port 577 or external interface 581 (e.g. Ethernet, Wi-Fi, etc.) can be used to connect computer system 510 to a wide area network such as the

Internet, a mouse input device, or a scanner. The interconnection via system bus 575 allows the central processor 573 to communicate with each subsystem and to control the execution of a plurality of instructions from system memory 572 or the storage device(s) 579 (e.g., a fixed disk, such as a hard drive, or optical disk), as well as the exchange of information between subsystems. Central processor 573 can be one or more processors of a central computing device (e.g., one or more data processors). The system memory 572 and/or the storage device(s) 579 may embody a non-transitory computer readable medium. Another subsystem is a data collection device 585, such as a camera, microphone, accelerometer, and the like. Any of the data mentioned herein can be output from one component to another component and can be output to the user.

A computer system can include a plurality of the same components or subsystems, e.g., connected together by external interface 581, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components.

Aspects of embodiments can be implemented in the form of control logic using hardware circuitry (e.g. an application specific integrated circuit or field programmable gate array) and/or using computer software stored in a memory with a generally programmable processor in a modular or integrated manner, and thus a processor can include memory storing software instructions that configure hardware circuitry, as well as an FPGA with configuration instructions or an ASIC. As used herein, a processor can include a single-core processor, multi-core processor on a same integrated chip, or multiple processing units on a single circuit board or networked, as well as dedicated hardware. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium such as a compact disk (CD) or DVD (digital versatile disk) or Blu-ray disk, flash memory, and the like. The computer readable medium may be any combination of such devices. In addition, the order of operations may be re-arranged. A process can be terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Such programs may also be encoded and transmitted using carrier signals adapted for transmission via wired, optical, and/or wireless networks conforming to a variety of protocols, including the Internet. As such, a computer readable medium may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

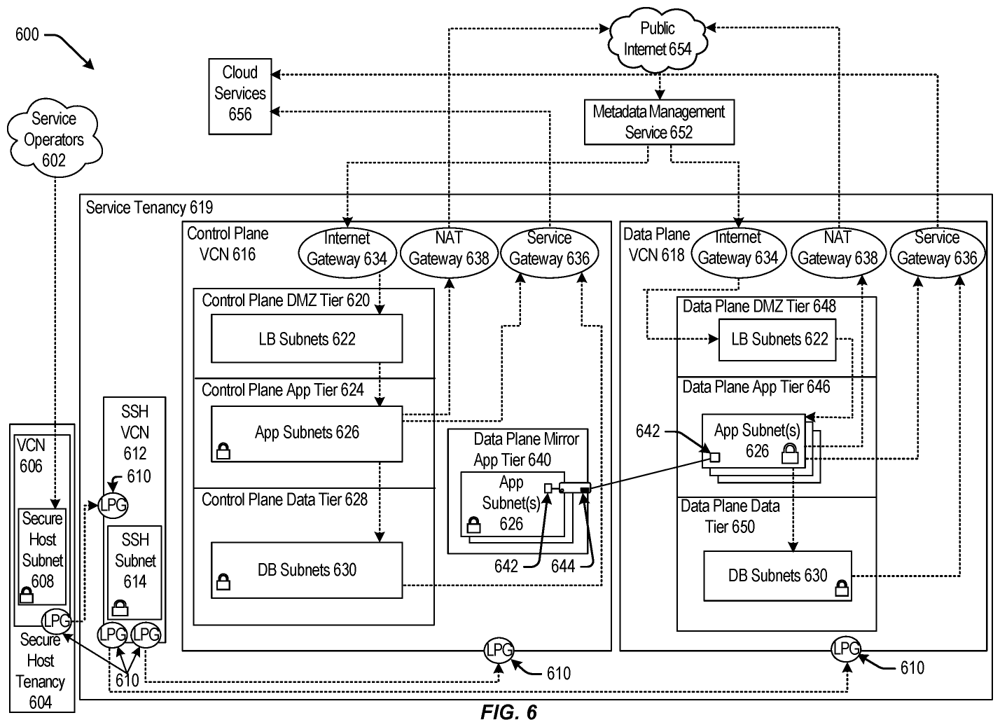

FIG. 6 is a block diagram 600 illustrating an example pattern of an IaaS architecture, according to at least one embodiment. Service operators 602 can be communicatively coupled to a secure host tenancy 604 that can include a virtual cloud network (VCN) 606 and a secure host subnet 608. In some examples, the service operators 602 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 606 and/or the Internet.

The VCN 606 can include a local peering gateway (LPG) 610 that can be communicatively coupled to a secure shell (SSH) VCN 612 via an LPG 610 contained in the SSH VCN 612. The SSH VCN 612 can include an SSH subnet 614, and the SSH VCN 612 can be communicatively coupled to a control plane VCN 616 via the LPG 610 contained in the control plane VCN 616. Also, the SSH VCN 612 can be communicatively coupled to a data plane VCN 618 via an LPG 610. The control plane VCN 616 and the data plane VCN 618 can be contained in a service tenancy 619 that can be owned and/or operated by the IaaS provider.

The control plane VCN 616 can include a control plane demilitarized zone (DMZ) tier 620 that acts as a perimeter network (e.g., portions of a corporate network between the corporate intranet and external networks). The DMZ-based servers may have restricted responsibilities and help keep breaches contained. Additionally, the DMZ tier 620 can include one or more load balancer (LB) subnet(s) 622, a control plane app tier 624 that can include app subnet(s) 626, a control plane data tier 628 that can include database (DB) subnet(s) 630 (e.g., frontend DB subnet(s) and/or backend DB subnet(s)). The LB subnet(s) 622 contained in the control plane DMZ tier 620 can be communicatively coupled to the app subnet(s) 626 contained in the control plane app tier 624 and an Internet gateway 634 that can be contained in the control plane VCN 616, and the app subnet(s) 626 can be communicatively coupled to the DB subnet(s) 630 contained in the control plane data tier 628 and a service gateway 636 and a network address translation (NAT) gateway 638. The control plane VCN 616 can include the service gateway 636 and the NAT gateway 638.

The control plane VCN 616 can include a data plane mirror app tier 640 that can include app subnet(s) 626. The app subnet(s) 626 contained in the data plane mirror app tier 640 can include a virtual network interface controller (VNIC) 642 that can execute a compute instance 644. The compute instance 644 can communicatively couple the app subnet(s) 626 of the data plane mirror app tier 640 to app subnet(s) 626 that can be contained in a data plane app tier 646.

The data plane VCN 618 can include the data plane app tier 646, a data plane DMZ tier 648, and a data plane data tier 650. The data plane DMZ tier 648 can include LB subnet(s) 622 that can be communicatively coupled to the app subnet(s) 626 of the data plane app tier 646 and the Internet gateway 634 of the data plane VCN 618. The app subnet(s) 626 can be communicatively coupled to the service gateway 636 of the data plane VCN 618 and the NAT gateway 638 of the data plane VCN 618. The data plane data tier 650 can also include the DB subnet(s) 630 that can be communicatively coupled to the app subnet(s) 626 of the data plane app tier 646.

The Internet gateway 634 of the control plane VCN 616 and of the data plane VCN 618 can be communicatively coupled to a metadata management service 652 that can be communicatively coupled to public Internet 654. Public Internet 654 can be communicatively coupled to the NAT gateway 638 of the control plane VCN 616 and of the data plane VCN 618. The service gateway 636 of the control plane VCN 616 and of the data plane VCN 618 can be communicatively coupled to cloud services 656.

In some examples, the service gateway 636 of the control plane VCN 616 or of the data plane VCN 618 can make application programming interface (API) calls to cloud services 656 without going through public Internet 654. The API calls to cloud services 656 from the service gateway 636 can be one-way: the service gateway 636 can make API calls to cloud services 656, and cloud services 656 can send requested data to the service gateway 636. But, cloud services 656 may not initiate API calls to the service gateway 636.

In some examples, the secure host tenancy 604 can be directly connected to the service tenancy 619, which may be otherwise isolated. The secure host subnet 608 can communicate with the SSH subnet 614 through an LPG 610 that may enable two-way communication over an otherwise isolated system. Connecting the secure host subnet 608 to the SSH subnet 614 may give the secure host subnet 608 access to other entities within the service tenancy 619.

The control plane VCN 616 may allow users of the service tenancy 619 to set up or otherwise provision desired resources. Desired resources provisioned in the control plane VCN 616 may be deployed or otherwise used in the data plane VCN 618. In some examples, the control plane VCN 616 can be isolated from the data plane VCN 618, and the data plane mirror app tier 640 of the control plane VCN 616 can communicate with the data plane app tier 646 of the data plane VCN 618 via VNICs 642 that can be contained in the data plane mirror app tier 640 and the data plane app tier 646.

In some examples, users of the system, or customers, can make requests, for example create, read, update, or delete (CRUD) operations, through public Internet 654 that can communicate the requests to the metadata management service 652. The metadata management service 652 can communicate the request to the control plane VCN 616 through the Internet gateway 634. The request can be received by the LB subnet(s) 622 contained in the control plane DMZ tier 620. The LB subnet(s) 622 may determine that the request is valid, and in response to this determination, the LB subnet(s) 622 can transmit the request to app subnet(s) 626 contained in the control plane app tier 624. If the request is validated and requires a call to public Internet 654, the call to public Internet 654 may be transmitted to the NAT gateway 638 that can make the call to public Internet 654. Metadata that may be desired to be stored by the request can be stored in the DB subnet(s) 630.

In some examples, the data plane mirror app tier 640 can facilitate direct

communication between the control plane VCN 616 and the data plane VCN 618. For example, changes, updates, or other suitable modifications to configuration may be desired to be applied to the resources contained in the data plane VCN 618. Via a VNIC 642, the control plane VCN 616 can directly communicate with, and can thereby execute the changes, updates, or other suitable modifications to configuration to, resources contained in the data plane VCN 618.

In some embodiments, the control plane VCN 616 and the data plane VCN 618 can be contained in the service tenancy 619. In this case, the user, or the customer, of the system may not own or operate either the control plane VCN 616 or the data plane VCN 618. Instead, the IaaS provider may own or operate the control plane VCN 616 and the data plane VCN 618, both of which may be contained in the service tenancy 619. This embodiment can enable isolation of networks that may prevent users or customers from interacting with other users', or other customers', resources. Also, this embodiment may allow users or customers of the system to store databases privately without needing to rely on public Internet 654, which may not have a desired level of threat prevention, for storage.

In other embodiments, the LB subnet(s) 622 contained in the control plane VCN 616 can be configured to receive a signal from the service gateway 636. In this embodiment, the control plane VCN 616 and the data plane VCN 618 may be configured to be called by a customer of the IaaS provider without calling public Internet 654. Customers of the IaaS provider may desire this embodiment since database(s) that the customers use may be controlled by the IaaS provider and may be stored on the service tenancy 619, which may be isolated from public Internet 654.

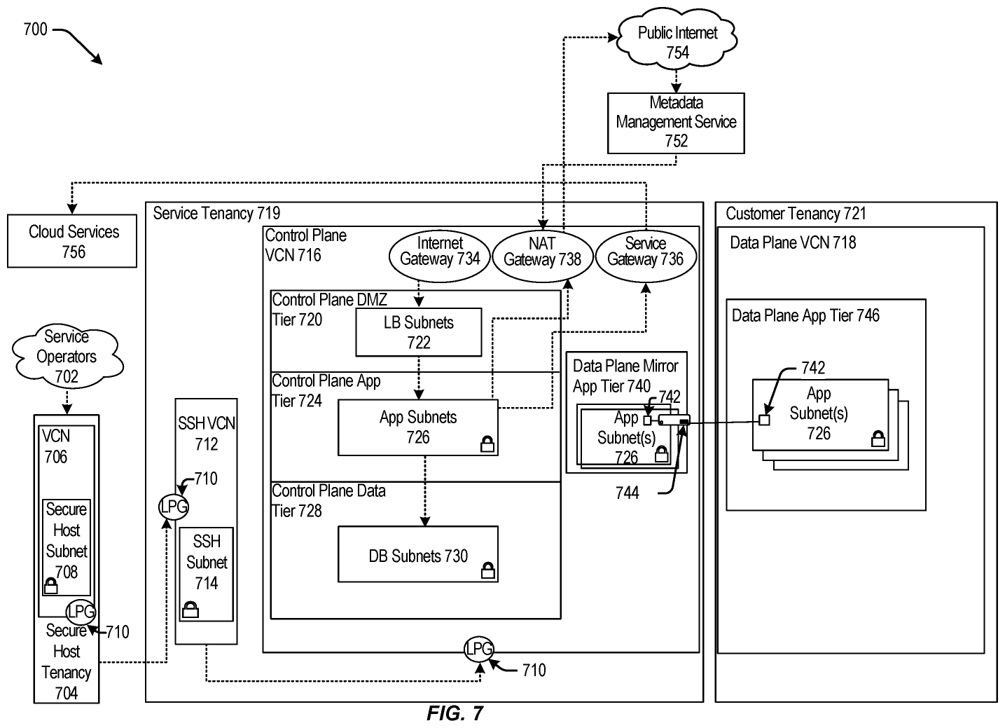

FIG. 7 is a block diagram 700 illustrating another example pattern of an IaaS architecture, according to at least one embodiment. Service operators 702 (e.g., service operators 602 of FIG. 6) can be communicatively coupled to a secure host tenancy 704 (e.g., the secure host tenancy 604 of FIG. 6) that can include a virtual cloud network (VCN) 706 (e.g., the VCN 606 of FIG. 6) and a secure host subnet 708 (e.g., the secure host subnet 608 of FIG. 6). The VCN 706 can include a local peering gateway (LPG) 710 (e.g., the LPG 610 of FIG. 6) that can be communicatively coupled to a secure shell (SSH) VCN 712 (e.g., the SSH VCN 612 of FIG. 6) via an LPG 610 contained in the SSH VCN 712. The SSH VCN 712 can include an SSH subnet 714 (e.g., the SSH subnet 614 of FIG. 6), and the SSH VCN 712 can be communicatively coupled to a control plane VCN 716 (e.g., the control plane VCN 616 of FIG. 6) via an LPG 710 contained in the control plane VCN 716. The control plane VCN 716 can be contained in a service tenancy 719 (e.g., the service tenancy 619 of FIG. 6), and the data plane VCN 718 (e.g., the data plane VCN 618 of FIG. 6) can be contained in a customer tenancy 721 that may be owned or operated by users, or customers, of the system.

The control plane VCN 716 can include a control plane DMZ tier 720 (e.g., the control plane DMZ tier 620 of FIG. 6) that can include LB subnet(s) 722 (e.g., LB subnet(s) 622 of FIG. 6), a control plane app tier 724 (e.g., the control plane app tier 624 of FIG. 6) that can include app subnet(s) 726 (e.g., app subnet(s) 626 of FIG. 6), a control plane data tier 728 (e.g., the control plane data tier 628 of FIG. 6) that can include database (DB) subnet(s) 730 (e.g., similar to DB subnet(s) 630 of FIG. 6). The LB subnet(s) 722 contained in the control plane DMZ tier 720 can be communicatively coupled to the app subnet(s) 726 contained in the control plane app tier 724 and an Internet gateway 734 (e.g., the Internet gateway 634 of FIG. 6) that can be contained in the control plane VCN 716, and the app subnet(s) 726 can be communicatively coupled to the DB subnet(s) 730 contained in the control plane data tier 728 and a service gateway 736 (e.g., the service gateway 636 of FIG. 6) and a network address translation (NAT) gateway 738 (e.g., the NAT gateway 638 of FIG. 6). The control plane VCN 716 can include the service gateway 736 and the NAT gateway 738.

The control plane VCN 716 can include a data plane mirror app tier 740 (e.g., the data plane mirror app tier 640 of FIG. 6) that can include app subnet(s) 726. The app subnet(s) 726 contained in the data plane mirror app tier 740 can include a virtual network interface controller (VNIC) 742 (e.g., the VNIC of 642) that can execute a compute instance 744 (e.g., similar to the compute instance 644 of FIG. 6). The compute instance 744 can facilitate communication between the app subnet(s) 726 of the data plane mirror app tier 740 and the app subnet(s) 726 that can be contained in a data plane app tier 746 (e.g., the data plane app tier 646 of FIG. 6) via the VNIC 742 contained in the data plane mirror app tier 740 and the VNIC 742 contained in the data plane app tier 746.

The Internet gateway 734 contained in the control plane VCN 716 can be communicatively coupled to a metadata management service 752 (e.g., the metadata management service 652 of FIG. 6) that can be communicatively coupled to public Internet 754 (e.g., public Internet 654 of FIG. 6). Public Internet 754 can be communicatively coupled to the NAT gateway 738 contained in the control plane VCN 716. The service gateway 736 contained in the control plane VCN 716 can be communicatively coupled to cloud services 756 (e.g., cloud services 656 of FIG. 6).

In some examples, the data plane VCN 718 can be contained in the customer tenancy 721. In this case, the IaaS provider may provide the control plane VCN 716 for each customer, and the IaaS provider may, for each customer, set up a unique compute instance 744 that is contained in the service tenancy 719. Each compute instance 744 may allow communication between the control plane VCN 716, contained in the service tenancy 719, and the data plane VCN 718 that is contained in the customer tenancy 721. The compute instance 744 may allow resources, that are provisioned in the control plane VCN 716 that is contained in the service tenancy 719, to be deployed or otherwise used in the data plane VCN 718 that is contained in the customer tenancy 721.

In other examples, the customer of the IaaS provider may have databases that live in the customer tenancy 721. In this example, the control plane VCN 716 can include the data plane mirror app tier 740 that can include app subnet(s) 726. The data plane mirror app tier 740 can reside in the data plane VCN 718, but the data plane mirror app tier 740 may not live in the data plane VCN 718. That is, the data plane mirror app tier 740 may have access to the customer tenancy 721, but the data plane mirror app tier 740 may not exist in the data plane VCN 718 or be owned or operated by the customer of the IaaS provider. The data plane mirror app tier 740 may be configured to make calls to the data plane VCN 718 but may not be configured to make calls to any entity contained in the control plane VCN 716. The customer may desire to deploy or otherwise use resources in the data plane VCN 718 that are provisioned in the control plane VCN 716, and the data plane mirror app tier 740 can facilitate the desired deployment, or other usage of resources, of the customer.

In some embodiments, the customer of the IaaS provider can apply filters to the data plane VCN 718. In this embodiment, the customer can determine what the data plane VCN 718 can access, and the customer may restrict access to public Internet 754 from the data plane VCN 718. The IaaS provider may not be able to apply filters or otherwise control access of the data plane VCN 718 to any outside networks or databases. Applying filters and controls by the customer onto the data plane VCN 718, contained in the customer tenancy 721, can help isolate the data plane VCN 718 from other customers and from public Internet 754.

In some embodiments, cloud services 756 can be called by the service gateway 736 to access services that may not exist on public Internet 754, on the control plane VCN 716, or on the data plane VCN 718. The connection between cloud services 756 and the control plane VCN 716 or the data plane VCN 718 may not be live or continuous. Cloud services 756 may exist on a different network owned or operated by the IaaS provider. Cloud services 756 may be configured to receive calls from the service gateway 736 and may be configured to not receive calls from public Internet 754. Some cloud services 756 may be isolated from other cloud services 756, and the control plane VCN 716 may be isolated from cloud services 756 that may not be in the same region as the control plane VCN 716. For example, the control plane VCN 716 may be located in “Region 1,” and cloud service “Deployment 6,” may be located in Region 1 and in “Region 2.” If a call to Deployment 6 is made by the service gateway 736 contained in the control plane VCN 716 located in Region 1, the call may be transmitted to Deployment 6 in Region 1. In this example, the control plane VCN 716, or Deployment 6 in Region 1, may not be communicatively coupled to, or otherwise in communication with, Deployment 6 in Region 2.

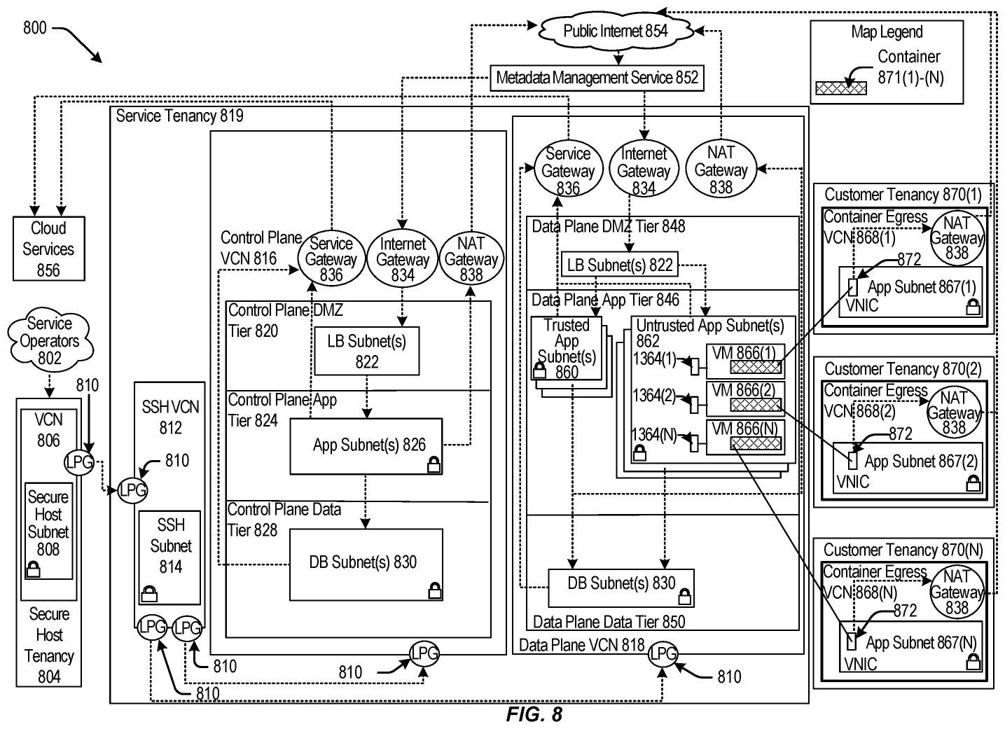

FIG. 8 is a block diagram 800 illustrating another example pattern of an IaaS architecture, according to at least one embodiment. Service operators 802 (e.g., service operators 602 of FIG. 6) can be communicatively coupled to a secure host tenancy 804 (e.g., the secure host tenancy 604 of FIG. 6) that can include a virtual cloud network (VCN) 806 (e.g., the VCN 606 of FIG. 6) and a secure host subnet 808 (e.g., the secure host subnet 608 of FIG. 6). The VCN 806 can include an LPG 810 (e.g., the LPG 610 of FIG. 6) that can be communicatively coupled to an SSH VCN 812 (e.g., the SSH VCN 612 of FIG. 6) via an LPG 810 contained in the SSH VCN 812. The SSH VCN 812 can include an SSH subnet 814 (e.g., the SSH subnet 614 of FIG. 6), and the SSH VCN 812 can be communicatively coupled to a control plane VCN 816 (e.g., the control plane VCN 616 of FIG. 6) via an LPG 810 contained in the control plane VCN 816 and to a data plane VCN 818 (e.g., the data plane 618 of FIG. 6) via an LPG 810 contained in the data plane VCN 818. The control plane VCN 816 and the data plane VCN 818 can be contained in a service tenancy 819 (e.g., the service tenancy 619 of FIG. 6).

The control plane VCN 816 can include a control plane DMZ tier 820 (e.g., the control plane DMZ tier 620 of FIG. 6) that can include load balancer (LB) subnet(s) 822 (e.g., LB subnet(s) 622 of FIG. 6), a control plane app tier 824 (e.g., the control plane app tier 624 of FIG. 6) that can include app subnet(s) 826 (e.g., similar to app subnet(s) 626 of FIG. 6), a control plane data tier 828 (e.g., the control plane data tier 628 of FIG. 6) that can include DB subnet(s) 830. The LB subnet(s) 822 contained in the control plane DMZ tier 820 can be communicatively coupled to the app subnet(s) 826 contained in the control plane app tier 824 and to an Internet gateway 834 (e.g., the Internet gateway 634 of FIG. 6) that can be contained in the control plane VCN 816, and the app subnet(s) 826 can be communicatively coupled to the DB subnet(s) 830 contained in the control plane data tier 828 and to a service gateway 836 (e.g., the service gateway of FIG. 6) and a network address translation (NAT) gateway 838 (e.g., the NAT gateway 638 of FIG. 6). The control plane VCN 816 can include the service gateway 836 and the NAT gateway 838.

The data plane VCN 818 can include a data plane app tier 846 (e.g., the data plane app tier 646 of FIG. 6), a data plane DMZ tier 848 (e.g., the data plane DMZ tier 648 of FIG. 6), and a data plane data tier 850 (e.g., the data plane data tier 650 of FIG. 6). The data plane DMZ tier 848 can include LB subnet(s) 822 that can be communicatively coupled to trusted app subnet(s) 860 and untrusted app subnet(s) 862 of the data plane app tier 846 and the Internet gateway 834 contained in the data plane VCN 818. The trusted app subnet(s) 860 can be communicatively coupled to the service gateway 836 contained in the data plane VCN 818, the NAT gateway 838 contained in the data plane VCN 818, and DB subnet(s) 830 contained in the data plane data tier 850. The untrusted app subnet(s) 862 can be communicatively coupled to the service gateway 836 contained in the data plane VCN 818 and DB subnet(s) 830 contained in the data plane data tier 850. The data plane data tier 850 can include DB subnet(s) 830 that can be communicatively coupled to the service gateway 836 contained in the data plane VCN 818.

The untrusted app subnet(s) 862 can include one or more primary VNICs 864(1)-(N) that can be communicatively coupled to tenant virtual machines (VMs) 866(1)-(N). Each tenant VM 866(1)-(N) can be communicatively coupled to a respective app subnet 867(1)-(N) that can be contained in respective container egress VCNs 868(1)-(N) that can be contained in respective customer tenancies 870(1)-(N). Respective secondary VNICs 872(1)-(N) can facilitate communication between the untrusted app subnet(s) 862 contained in the data plane VCN 818 and the app subnet contained in the container egress VCNs 868(1)-(N). Each container egress VCNs 868(1)-(N) can include a NAT gateway 838 that can be communicatively coupled to public Internet 854 (e.g., public Internet 654 of FIG. 6).

The Internet gateway 834 contained in the control plane VCN 816 and contained in the data plane VCN 818 can be communicatively coupled to a metadata management service 852 (e.g., the metadata management system 652 of FIG. 6) that can be communicatively coupled to public Internet 854. Public Internet 854 can be communicatively coupled to the NAT gateway 838 contained in the control plane VCN 816 and contained in the data plane VCN 818. The service gateway 836 contained in the control plane VCN 816 and contained in the data plane VCN 818 can be communicatively coupled to cloud services 856.

In some embodiments, the data plane VCN 818 can be integrated with customer tenancies 870. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 846. Code to run the function may be executed in the VMs 866(1)-(N), and the code may not be configured to run anywhere else on the data plane VCN 818. Each VM 866(1)-(N) may be connected to one customer tenancy 870. Respective containers 871(1)-(N) contained in the VMs 866(1)-(N) may be configured to run the code. In this case, there can be a dual isolation (e.g., the containers 871(1)-(N) running code, where the containers 871(1)-(N) may be contained in at least the VM 866(1)-(N) that are contained in the untrusted app subnet(s) 862), which may help prevent incorrect or otherwise undesirable code from damaging the network of the IaaS provider or from damaging a network of a different customer. The containers 871(1)-(N) may be communicatively coupled to the customer tenancy 870 and may be configured to transmit or receive data from the customer tenancy 870. The containers 871(1)-(N) may not be configured to transmit or receive data from any other entity in the data plane VCN 818. Upon completion of running the code, the IaaS provider may kill or otherwise dispose of the containers 871(1)-(N).

In some embodiments, the trusted app subnet(s) 860 may run code that may be owned or operated by the IaaS provider. In this embodiment, the trusted app subnet(s) 860 may be communicatively coupled to the DB subnet(s) 830 and be configured to execute CRUD operations in the DB subnet(s) 830. The untrusted app subnet(s) 862 may be communicatively coupled to the DB subnet(s) 830, but in this embodiment, the untrusted app subnet(s) may be configured to execute read operations in the DB subnet(s) 830. The containers 871(1)-(N) that can be contained in the VM 866(1)-(N) of each customer and that may run code from the customer may not be communicatively coupled with the DB subnet(s) 830.

In other embodiments, the control plane VCN 816 and the data plane VCN 818 may not be directly communicatively coupled. In this embodiment, there may be no direct communication between the control plane VCN 816 and the data plane VCN 818. However, communication can occur indirectly through at least one method. An LPG 810 may be established by the IaaS provider that can facilitate communication between the control plane VCN 816 and the data plane VCN 818. In another example, the control plane VCN 816 or the data plane VCN 818 can make a call to cloud services 856 via the service gateway 836. For example, a call to cloud services 856 from the control plane VCN 816 can include a request for a service that can communicate with the data plane VCN 818.

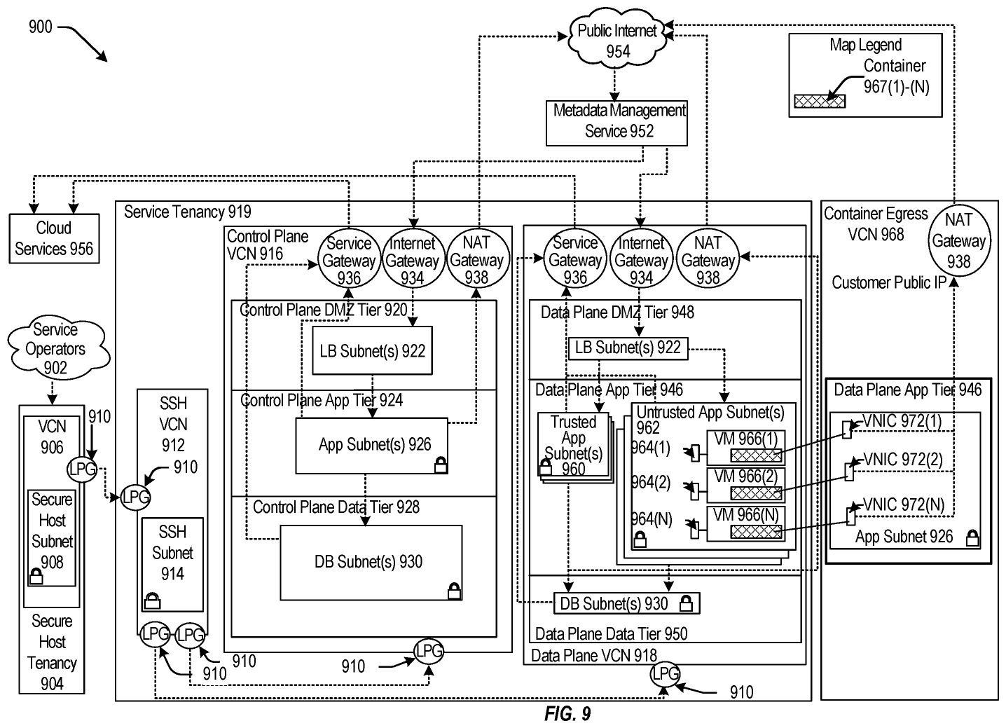

FIG. 9 is a block diagram 900 illustrating another example pattern of an IaaS architecture, according to at least one embodiment. Service operators 902 (e.g., service operators 602 of FIG. 6) can be communicatively coupled to a secure host tenancy 904 (e.g., the secure host tenancy 604 of FIG. 6) that can include a virtual cloud network (VCN) 906 (e.g., the VCN 606 of FIG. 6) and a secure host subnet 908 (e.g., the secure host subnet 608 of FIG. 6). The VCN 906 can include an LPG 910 (e.g., the LPG 610 of FIG. 6) that can be communicatively coupled to an SSH VCN 912 (e.g., the SSH VCN 612 of FIG. 6) via an LPG 910 contained in the SSH VCN 912. The SSH VCN 912 can include an SSH subnet 914 (e.g., the SSH subnet 614 of FIG. 6), and the SSH VCN 912 can be communicatively coupled to a control plane VCN 916 (e.g., the control plane VCN 616 of FIG. 6) via an LPG 910 contained in the control plane VCN 916 and to a data plane VCN 918 (e.g., the data plane 618 of FIG. 6) via an LPG 910 contained in the data plane VCN 918. The control plane VCN 916 and the data plane VCN 918 can be contained in a service tenancy 919 (e.g., the service tenancy 619 of FIG. 6).

The control plane VCN 916 can include a control plane DMZ tier 920 (e.g., the control plane DMZ tier 620 of FIG. 6) that can include LB subnet(s) 922 (e.g., LB subnet(s) 622 of FIG. 6), a control plane app tier 924 (e.g., the control plane app tier 624 of FIG. 6) that can include app subnet(s) 926 (e.g., app subnet(s) 626 of FIG. 6), a control plane data tier 928 (e.g., the control plane data tier 628 of FIG. 6) that can include DB subnet(s) 930 (e.g., DB subnet(s) 830 of FIG. 8). The LB subnet(s) 922 contained in the control plane DMZ tier 920 can be communicatively coupled to the app subnet(s) 926 contained in the control plane app tier 924 and to an Internet gateway 934 (e.g., the Internet gateway 634 of FIG. 6) that can be contained in the control plane VCN 916, and the app subnet(s) 926 can be communicatively coupled to the DB subnet(s) 930 contained in the control plane data tier 928 and to a service gateway 936 (e.g., the service gateway of FIG. 6) and a network address translation (NAT) gateway 938 (e.g., the NAT gateway 638 of FIG. 6). The control plane VCN 916 can include the service gateway 936 and the NAT gateway 938.

The data plane VCN 918 can include a data plane app tier 946 (e.g., the data plane app tier 646 of FIG. 6), a data plane DMZ tier 948 (e.g., the data plane DMZ tier 648 of FIG. 6), and a data plane data tier 950 (e.g., the data plane data tier 650 of FIG. 6). The data plane DMZ tier 948 can include LB subnet(s) 922 that can be communicatively coupled to trusted app subnet(s) 960 (e.g., trusted app subnet(s) 860 of FIG. 8) and untrusted app subnet(s) 962 (e.g., untrusted app subnet(s) 862 of FIG. 8) of the data plane app tier 946 and the Internet gateway 934 contained in the data plane VCN 918. The trusted app subnet(s) 960 can be communicatively coupled to the service gateway 936 contained in the data plane VCN 918, the NAT gateway 938 contained in the data plane VCN 918, and DB subnet(s) 930 contained in the data plane data tier 950. The untrusted app subnet(s) 962 can be communicatively coupled to the service gateway 936 contained in the data plane VCN 918 and DB subnet(s) 930 contained in the data plane data tier 950. The data plane data tier 950 can include DB subnet(s) 930 that can be communicatively coupled to the service gateway 936 contained in the data plane VCN 918.

The untrusted app subnet(s) 962 can include primary VNICs 964(1)-(N) that can be communicatively coupled to tenant virtual machines (VMs) 966(1)-(N) residing within the untrusted app subnet(s) 962. Each tenant VM 966(1)-(N) can run code in a respective container 967(1)-(N), and be communicatively coupled to an app subnet 926 that can be contained in a data plane app tier 946 that can be contained in a container egress VCN 968. Respective secondary VNICs 972(1)-(N) can facilitate communication between the untrusted app subnet(s) 962 contained in the data plane VCN 918 and the app subnet contained in the container egress VCN 968. The container egress VCN can include a NAT gateway 938 that can be communicatively coupled to public Internet 954 (e.g., public Internet 654 of FIG. 6).

The Internet gateway 934 contained in the control plane VCN 916 and contained in the data plane VCN 918 can be communicatively coupled to a metadata management service 952 (e.g., the metadata management system 652 of FIG. 6) that can be communicatively coupled to public Internet 954. Public Internet 954 can be communicatively coupled to the NAT gateway 938 contained in the control plane VCN 916 and contained in the data plane VCN 918. The service gateway 936 contained in the control plane VCN 916 and contained in the data plane VCN 918 can be communicatively coupled to cloud services 956.

In some examples, the pattern illustrated by the architecture of block diagram 900 of FIG. 9 may be considered an exception to the pattern illustrated by the architecture of block diagram 800 of FIG. 8 and may be desirable for a customer of the IaaS provider if the IaaS provider cannot directly communicate with the customer (e.g., a disconnected region). The respective containers 967(1)-(N) that are contained in the VMs 966(1)-(N) for each customer can be accessed in real-time by the customer. The containers 967(1)-(N) may be configured to make calls to respective secondary VNICs 972(1)-(N) contained in app subnet(s) 926 of the data plane app tier 946 that can be contained in the container egress VCN 968. The secondary VNICs 972(1)-(N) can transmit the calls to the NAT gateway 938 that may transmit the calls to public Internet 954. In this example, the containers 967(1)-(N) that can be accessed in real-time by the customer can be isolated from the control plane VCN 916 and can be isolated from other entities contained in the data plane VCN 918. The containers 967(1)-(N) may also be isolated from resources from other customers.

In other examples, the customer can use the containers 967(1)-(N) to call cloud services 956. In this example, the customer may run code in the containers 967(1)-(N) that requests a service from cloud services 956. The containers 967(1)-(N) can transmit this request to the secondary VNICs 972(1)-(N) that can transmit the request to the NAT gateway that can transmit the request to public Internet 954. Public Internet 954 can transmit the request to LB subnet(s) 922 contained in the control plane VCN 916 via the Internet gateway 934. In response to determining the request is valid, the LB subnet(s) can transmit the request to app subnet(s) 926 that can transmit the request to cloud services 956 via the service gateway 936.

It should be appreciated that IaaS architectures 600, 700, 800, 900 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

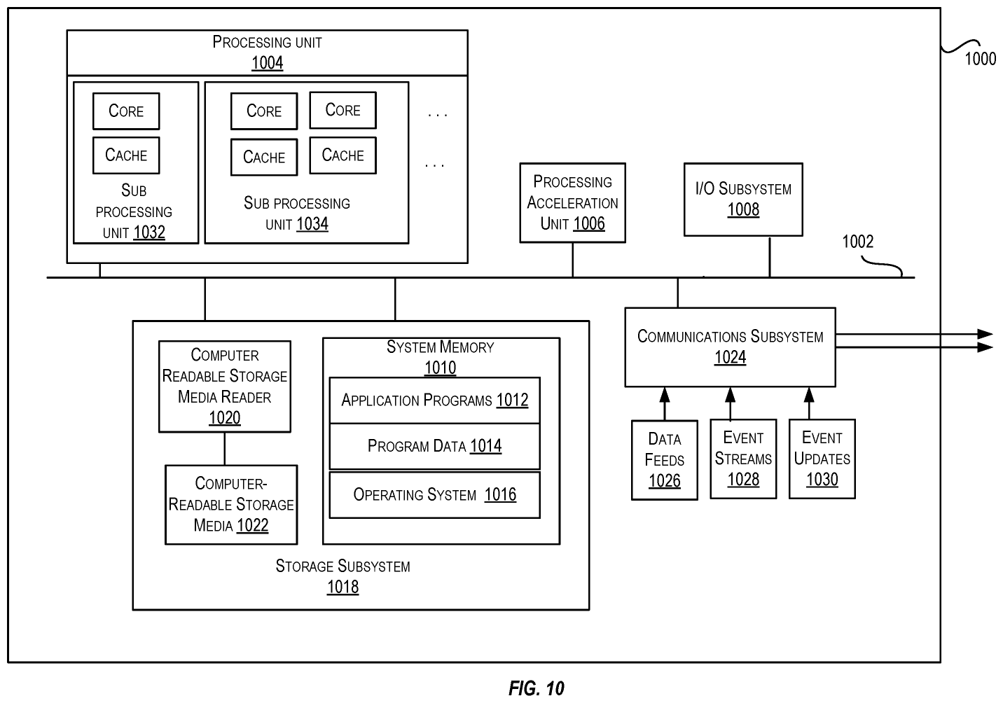

FIG. 10 illustrates an example computer system 1000, in which various embodiments may be implemented. The system 1000 may be used to implement any of the computer systems described above. As shown in the figure, computer system 1000 includes a processing unit 1004 that communicates with a number of peripheral subsystems via a bus subsystem 1002. These peripheral subsystems may include a processing acceleration unit 1006, an I/O subsystem 1008, a storage subsystem 1018 and a communications subsystem 1024. Storage subsystem 1018 includes tangible computer-readable storage media 1022 and a system memory 1010.

Bus subsystem 1002 provides a mechanism for letting the various components and subsystems of computer system 1000 communicate with each other as intended. Although bus subsystem 1002 is shown schematically as a single bus, alternative embodiments of the bus subsystem may utilize multiple buses. Bus subsystem 1002 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1004, which can be implemented as one or more integrated circuits (e.g., a conventional microprocessor or microcontroller), controls the operation of computer system 1000. One or more processors may be included in processing unit 1004. These processors may include single core or multicore processors. In certain embodiments, processing unit 1004 may be implemented as one or more independent processing units 1032 and/or 1034 with single or multicore processors included in each processing unit. In other embodiments, processing unit 1004 may also be implemented as a quad-core processing unit formed by integrating two dual-core processors into a single chip.

In various embodiments, processing unit 1004 can execute a variety of programs in response to program code and can maintain multiple concurrently executing programs or processes. At any given time, some or all of the program code to be executed can be resident in processor(s) 1004 and/or in storage subsystem 1018. Through suitable programming, processor(s) 1004 can provide various functionalities described above. Computer system 1000 may additionally include a processing acceleration unit 1006, which can include a digital signal processor (DSP), a special-purpose processor, and/or the like.

I/O subsystem 1008 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1000 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1000 may comprise a storage subsystem 1018 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1004 provide the functionality described above. Storage subsystem 1018 may also provide a repository for storing data used in accordance with the present disclosure.

As depicted in the example in FIG. 10, storage subsystem 1018 can include various components including a system memory 1010, computer-readable storage media 1022, and a computer readable storage media reader 1020. System memory 1010 may store program instructions that are loadable and executable by processing unit 1004. System memory 1010 may also store data that is used during the execution of the instructions and/or data that is generated during the execution of the program instructions. Various different kinds of programs may be loaded into system memory 1010 including but not limited to client applications, Web browsers, mid-tier applications, relational database management systems (RDBMS), virtual machines, containers, etc.

System memory 1010 may also store an operating system 1016. Examples of operating system 1016 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1000 executes one or more virtual machines, the virtual machines along with their guest operating systems (GOSs) may be loaded into system memory 1010 and executed by one or more processors or cores of processing unit 1004.

System memory 1010 can come in different configurations depending upon the type of computer system 1000. For example, system memory 1010 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1010 may include a basic input/output system (BIOS) containing basic routines that help to transfer information between elements within computer system 1000, such as during start-up.

Computer-readable storage media 1022 may represent remote, local, fixed, and/or removable storage devices plus storage media for temporarily and/or more permanently containing, storing, computer-readable information for use by computer system 1000 including instructions executable by processing unit 1004 of computer system 1000.

Computer-readable storage media 1022 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1022 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1022 may include, but is not limited to, Zip® drives, flash memory cards, universal serial bus (USB) flash drives, secure digital (SD) cards, DVD disks, digital video tape, and the like. Computer-readable storage media 1022 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1000.

Machine-readable instructions executable by one or more processors or cores of processing unit 1004 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1024 provides an interface to other computer systems and networks. Communications subsystem 1024 serves as an interface for receiving data from and transmitting data to other systems from computer system 1000. For example, communications subsystem 1024 may enable computer system 1000 to connect to one or more devices via the Internet. In some embodiments communications subsystem 1024 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1024 can provide wired network connectivity (e.g., Ethernet) in addition to or instead of a wireless interface.

In some embodiments, communications subsystem 1024 may also receive input communication in the form of structured and/or unstructured data feeds 1026, event streams 1028, event updates 1030, and the like on behalf of one or more users who may use computer system 1000.

By way of example, communications subsystem 1024 may be configured to receive data feeds 1026 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1024 may also be configured to receive data in the form of continuous data streams, which may include event streams 1028 of real-time events and/or event updates 1030, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1024 may also be configured to output the structured and/or unstructured data feeds 1026, event streams 1028, event updates 1030, and the like to one or more databases that may be in communication with one or more streaming data source computers coupled to computer system 1000.

Computer system 1000 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1000 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method, comprising:
presenting, on a display of a computing device, a graphical user interface for creating a pipeline to transform data from a first format to a second format, wherein the graphical user interface comprises an interactive workspace and a logical entity library, wherein the pipeline comprises two or more logical entities, and wherein each logical entity in the logical entity library comprises at least one of a data processing node, a debugging node, or an administrative node;
for each logical entity in the pipeline:
receiving, via the graphical user interface of the computing device, information identifying a logical entity from the logical entity library;
receiving, via the graphical user interface of the computing device, information identifying a location within the interactive workspace for the logical entity; and
receiving, via the graphical user interface of the computing device, information identifying a configuration corresponding to the logical entity;
visually representing, via the graphical user interface of the computing device, a graphical connection between each logical entity in the pipeline and at least one additional logical entity in the pipeline, wherein the graphical connection indicates a flow of data in the pipeline;
transforming, by the computing device, data from the first format to the second format to produce transformed data based at least in part on the two or more logical entities comprising the pipeline.

2. The method of claim 1, wherein visually representing the graphical connection between each logical entity further comprises:
visually representing, via the graphical user interface of the computing device, two or more graphical connections between a logical entity in the pipeline and at least two additional logical entities.

3. The method of claim 2, wherein the at least two additional logical entities comprise a data processing node and a debugging node.

4. The method of claim 1, wherein presenting the graphical user interface comprises:
accessing, by the computing device, the logical entity library; and
registering, by the computing device, the logical entity library with the graphical user interface.

5. The method of claim 1, wherein the first format comprises unprocessed data and the second format comprises input to a machine learning model.

6. The method of claim 1, further comprising:
training, by the computing device, a machine learning model on the transformed data in the second format.

7. The method of claim 1, further comprising:
storing, by the computing device, the transformed data in a memory of the computing device.

8. A non-transitory computer-readable medium storing a set of instructions, the set of instructions comprising:
one or more instructions that, when executed by one or more processors of a computing device, cause the computing device to perform operations comprising:
presenting a graphical user interface for creating a pipeline to transform data from a first format to a second format, wherein the graphical user interface comprises an interactive workspace and a logical entity library, wherein the pipeline comprises two or more logical entities, and wherein each logical entity in the logical entity library comprises at least one of a data processing node, a debugging node, or an administrative node;
for each logical entity in the pipeline:
receiving, via the graphical user interface, information identifying a logical entity from the logical entity library;
receiving, via the graphical user interface, information identifying a location within the interactive workspace for the logical entity; and
receiving, via the graphical user interface, information identifying a configuration corresponding to the logical entity;
visually representing a graphical connection between each logical entity in the pipeline and at least one additional logical entity in the pipeline, wherein the graphical connection indicates a flow of data in the pipeline;
transforming data from the first format to the second format to produce transformed data based at least in part on the two or more logical entities comprising the pipeline.

9. The computer-readable medium of claim 8, wherein visually representing, via the graphical user interface, a graphical connection between each logical entity further comprises:
visually representing, via the graphical user interface, two or more graphical connections between a logical entity in the pipeline and at least two additional logical entities.

10. The computer-readable medium of claim 9, wherein the at least two additional logical entities comprise a data processing node and a debugging node.

11. The computer-readable medium of claim 8, wherein presenting the graphical user interface comprises:
accessing the logical entity library; and
registering the logical entity library with the graphical user interface.

12. The computer-readable medium of claim 8, wherein the first format comprises unprocessed data and the second format comprises input to a machine learning model.

13. The computer-readable medium of claim 8, further comprising:
training a machine learning model on the transformed data in the second format.

14. The computer-readable medium of claim 8, further comprising:
storing the transformed data in a memory of a computing device.

15. A system comprising:
one or more data processors; and
one or more non-transitory computer readable media storing instructions that, when executed by the one or more data processors, cause the one or more data processors to perform operations comprising:
presenting a graphical user interface for creating a pipeline to transform data from a first format to a second format, wherein the graphical user interface comprises an interactive workspace and a logical entity library, wherein the pipeline comprises two or more logical entities, and wherein each logical entity in the logical entity library comprises at least one of a data processing node, a debugging node, or an administrative node;
for each logical entity in the pipeline:
receiving, via the graphical user interface, information identifying a logical entity from the logical entity library;
receiving, via the graphical user interface, information identifying a location within the interactive workspace for the logical entity; and
receiving, via the graphical user interface, information identifying a configuration corresponding to the logical entity;
visually representing a graphical connection between each logical entity in the pipeline and at least one additional logical entity in the pipeline, wherein the graphical connection indicates a flow of data in the pipeline;
transforming data from the first format to the second format to produce transformed data based at least in part on the two or more logical entities comprising the pipeline.

16. The system of claim 15, wherein visually representing a graphical connection between each logical entity further comprises:
visually representing, via the graphical user interface, two or more graphical connections between a logical entity in the pipeline and at least two additional logical entities.

17. The system of claim 16, wherein the at least two additional logical entities comprise a data processing node and a debugging node.

18. The system of claim 15, wherein presenting the graphical user interface comprises:
accessing the logical entity library; and
registering the logical entity library with the graphical user interface.

19. The system of claim 15, wherein the first format comprises unprocessed data and the second format comprises input to a machine learning model.

20. The system of claim 15, further comprising:
training a machine learning model on the transformed data in the second format.
